(19) United States
(12) Patent Application Publication
(10) Pub. No.: US 2024/0254057 A1
(43) Pub. Date: Aug. 1, 2024

(54) HIGH-STRENGTH SELF-HEALING CAPSULE AND PRODUCTION PROCESS THEREOF

(71) Applicant: SHANDONG UNIVERSITY, Jinan, Shandong (CN)

(72) Inventors: Honglei CHANG, Jinan (CN); Jian LIU, Jinan (CN); Quanyi XIE, Jinan (CN)

(73) Assignee: SHANDONG UNIVERSITY, Jinan, Shandong (CN)

(21) Appl. No.: 18/017,707

(22) PCT Filed: Jul. 28, 2022
(86) PCT No.: PCT/CN2022/108695

§ 371 Date: Jan. 24, 2023

(30) Foreign Application Priority Data
Dec. 30, 2021 (CN) 2021116591603

(51) Int. Cl. C04B 40/00; C04B 7/40; C04B 18/14; C04B 20/10; C04B 111/00

(52) U.S. Cl. CPC C04B 40/0046; C04B 7/40; C04B 18/146; C04B 20/1033; C04B 2111/00318

(57) ABSTRACT

Provided is a high-strength self-healing capsule and a supporting production process thereof, belongs to the field of self-healing of concrete, comprising: healing agent and maltose; further comprising: mixing cement, silica fume and expansive materials evenly to obtain healing agent powder; mixing the healing agent powder with maltose to obtain healing agent composite powder; pre-pressing the healing agent composite powder to form fine granules; sieving the fine granules made from the pre-pressing, and granulating to obtain capsule core granules; and spraying polyvinyl alcohol (PVA) solution to the capsule core granules, while blowing hot air to remove moisture on the surface of the capsule core granules, for the PVA solution to form a film on the surface of the capsule core granules, drying, and then obtaining. On the basis of the process of the present invention, according to the engineering service environment and use requirements of the cement-based materials, suitable healing agent raw materials can be selected and combined to efficiently produce capsules, so that they can play a targeted role in self-healing.

### CROSS-REFERENCES TO RELATED APPLICATIONS

The present invention claims priority benefits to Chinese Patent Application No. 202111659160.3, filed 30 Dec. 2021, the contents of which are incorporated herein by reference.

### TECHNICAL FIELD

The present invention belongs to the field of self-healing of concrete, and specifically relates to a high-strength self-healing capsule and a supporting production process thereof.

### BACKGROUND

Information of the related art part is merely disclosed to increase the understanding of the overall background of the present invention, but is not necessarily regarded as acknowledging or suggesting, in any form, that the information constitutes the prior art known to a person of ordinary skill in the art.

With the large-scale application of concrete in modern constructions, it has gradually evolved toward high strength, high performance, versatility and intelligence. However, as concrete is a brittle material and has more holes, it is susceptible to cracks or local damage during the service process thereof due to environmental and other factors. If not repaired in time, it will affect the characteristics of concrete components such as compressive strength and tensile strength, thus affecting the normal use of the structure, and even threatening the stability of the structure. The self-healing technology for concrete does not require manual inspection and is the timeliest way to repair. Therefore, the research on the performance of damage/microcrack self-healing of cement-based materials has attracted extensive attention at home and abroad.

The use of microcapsules in the cement-based materials is one of the important measures to realize the self-healing. The self-healing technology based on microcapsules is to encapsulate the healing agent in a capsule, which is pre-buried inside the concrete structure in a certain ratio instead of sand or cement and is evenly distributed in the basal body after mixing. When a crack occurs in the concrete, the capsule wall of the microcapsules here will break under the action of the stress at the tip of the crack, and the healing agent is scattered and dispersed around the crack with water, generating hydration products or swelling substances deposited in the crack to fill the crack, thus achieving the effect of healing the crack. However, the current production methods of microcapsule self-healing technology mainly stay in the laboratory stage, such as in-situ polymerization method, extrusion method, spheronization method. The microcapsule yield is small and the production efficiency is low, which cannot meet the actual promotion and application of engineering. In addition, there are many problems in the preparation of microcapsules: first of all, in the process of manufacturing capsule cores, part of the healing agent undergoes hydration reaction in advance, which makes its subsequent restoration effect weakened; secondly, the granule size of the microcapsule is not easy to control, and the size of the manufactured capsule cores is difficult to achieve uniformity; the third, the utilization rate of raw materials is low, and there is a more serious waste problem; the fourth, the manufacturing efficiency and manufacturing quality are not high; and the fifth, the strength of the produced microcapsule is very low, which has a negative effect on the mechanical properties of the basal body. All the above disadvantages limit the large-scale application of microencapsulation technology.

### SUMMARY

To improve the production efficiency of self-healing materials and meet future engineering applications, the present invention provides a high-strength self-healing capsule with controllable granule size and shape and a supporting production process thereof. The core of the technology is to use a butterfly-type mixing machine, dry granulator, rotary pelleting machine and coating machine to complete the work of mixing, pre-granulation, granulation and film formation to form hard capsule granules and make the utilization rate of raw materials reaches 100%. The most important invention points of the present invention are: firstly, by adding maltose to the raw material of the healing agent to provide cohesion, the prepared capsule granules can maintain the pressed shape and have high strength; secondly, by pre-pressing the healing agent mixture by the dry granulator, the problem of poor flowability of the healing agent powder is solved; thirdly, a complete production process of such high-strength self-healing capsules is provided.

To achieve the above technical objectives, the present invention uses the following technical solutions.

It is a first aspect of the present invention to provide a high-strength self-healing capsule, comprising: healing agent and maltose.

To improve the production efficiency of self-healing materials and meet future engineering applications, the present invention provides a high-strength self-healing capsule and a supporting production process thereof.

It is a second aspect of the present invention to provide a method for preparing a high-strength self-healing capsule, comprising:
mixing cement, silica fume and expansive materials evenly to obtain healing agent powder;
mixing the healing agent powder with maltose to obtain healing agent composite powder;
pre-pressing the healing agent composite powder to form fine granules;
sieving the fine granules made from the pre-pressing, and granulating to obtain capsule core granules; and
spraying polyvinyl alcohol (PVA) solution to the capsule core granules, while blowing hot air to remove moisture on the surface of the capsule core granules, for the PVA solution to form a film on the surface of the capsule core granule, and drying, and then obtaining the high-strength self-healing capsule.

It is a third aspect of the present invention to provide an application of a high-strength self-healing capsule prepared by the above method in concrete self-healing.

The beneficial effects of the present invention are as follows:
(1) By directly pressing and granulating the healing agent powder, the bonding strength between the powders inside the granules produced is very low, which will cause obvious damage after the granules are out of the mold, leading to the failure of subsequent operations. Maltose can play the role of adhesive, thus providing cohesion; however, the amount of maltose should be controlled, that is, too much will reduce the proportion of effective ingredients in the capsule, and too little will lead to poor granulation effect of the capsule. Therefore, in the present invention, 3-10% maltose is added to the healing agent powder as the adhesive to solve the problem that the integrity of the granules in the capsule core cannot be guaranteed due to the poor adhesion effect of the healing agent, thus ensuring the integrity of the capsule core granules and improving the hardness of the capsule core. The hardness of the capsule is improved to ensure the mechanical properties and durability of the cement-based materials is not affected to the greatest extent.

(2) Due to the poor flowability of the healing agent powder and the small size of the capsules to be prepared, it is difficult for the powder to be automatically filled into the mold from the bin of the rotary pelleting machine (the diameter of the mold is 1-5 mm). Therefore, if the mixed healing agent powder is used directly in the rotary pelleting machine, the preparation of the capsule core granules will not be completed. In order to improve the flowability of the healing agent, the present invention proposes to pre-treat the mixture, which is, pre-pressing the mixture of healing agent powder and maltose by using the dry granulator to form 0.1-0.3 mm fine granules. After pre-pressing, the flowability of the healing agent is significantly improved and the problem of difficult automatic filling of the molds of the rotary pelleting machine is solved.

(3) According to the present invention, the mold of the rotary pelleting machine has been improved (as shown in FIG. 4) for preparing capsules of different shapes (spherical, cylindrical) and sizes (1-5 mm) as needed; meanwhile, the production efficiency of capsules can be greatly improved by increasing the number of molds and adjusting the rotary speed of the disc to realize the industrial mass production.

(4) According to the present invention, the preparation process of the capsule core does not involve water, thus greatly increasing the possibility of preparing different functional self-healing materials. Therefore, on the basis of the process of the present invention, suitable raw materials of healing agents can be preferably selected for combination according to the engineering service environment and usage requirements of cement-based materials to produce capsules with high efficiency, so that they can play the self-healing effect in a targeted manner. For example, if a persistent self-healing of crack damage needs to be achieved, a mineral expansive material may be considered to add to the formula of the healing agent; if the rapid water absorption and sealing need to be achieved, the macromolecule water absorbing resin or expanded rubber powder may be considered to add to the formula of the healing agent. The above two types of the formulas of the healing agent are difficult to prepare with the participation of water, and the use of water will partially react with the healing agent in advance, which greatly limits restoration effect and scope of use thereof.

(5) The hardness of the capsule core prepared by the method of the present invention is 200-300 times higher than that of the capsule core prepared by the traditional spheronization method, reaching 20-50N, and the hardness of the capsule wall can continue to be increased by 2-3 times after wrapping the outer capsule wall of PVA.

(6) According to the present invention, the operation method is simple, low cost, universal, and easy to be produced on a large scale.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of production devices of a high-strength self-healing capsule;

FIG. 2 is a flowchart of producing the high-strength self-healing capsule;

FIG. 3 is an instrument diagram of a rotary pelleting machine;

FIG. 4 is a schematic diagram of a pressing process; and

FIG. 5 is a schematic diagram of a novel capsule structure.

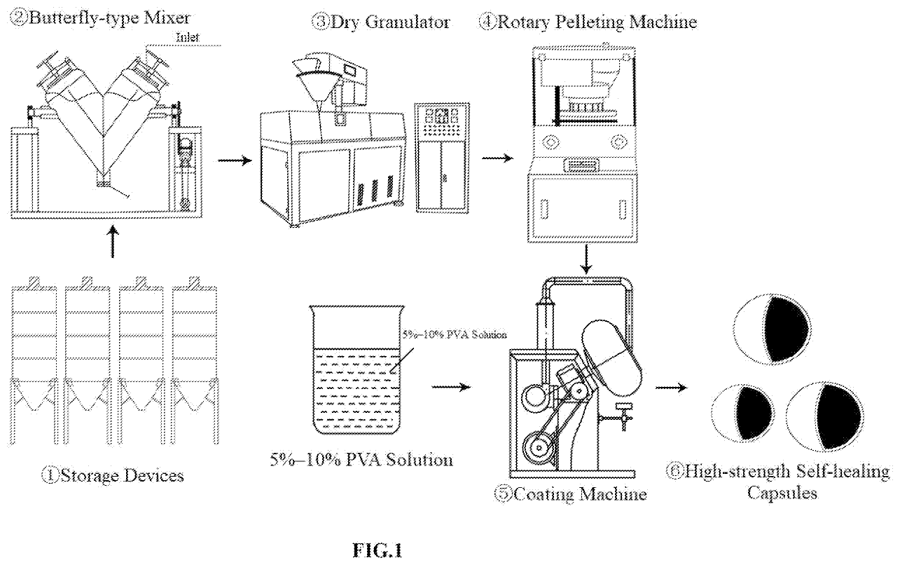

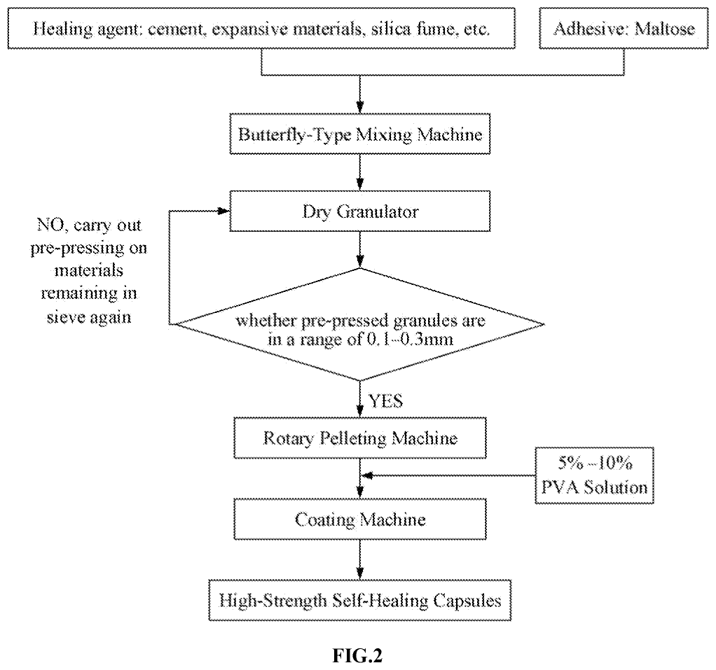

### DETAILED DESCRIPTION

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

The present invention will explain a preparation of a high-strength self-healing capsule with persistent self-healing ability by adding mineral expansive material and a supporting production process thereof.

Storing: healing agent powders such as cement, silica fume and expansive materials, and maltose powder as adhesive being contained in storage devices, respectively.

Silica fume is a mineral admixture with high pozzolanic activity, and may react with Ca(OH)₂ generated from cement hydration to form hydrated calcium silicate gel with low calcium silica ratio, for filling holes in the cement-based materials. When the capsule prepared with the silica fume as capsule core material of the capsule is mixed into the cement-based material, when the crack occurs and the capsule breaks, the silica fume inside the capsule is released to participate in the early hydration and produce crack healing materials. Wherein, the silica fume granules can play a “nucleation” role in the cement hydration products, thus promoting the cement hydration; moreover, the silica fume has a high fineness and aggregation tendency, and will not be completely consumed in the early stage, and can play a role in the later healing.

It should be noted that the type of the expansive material in the present invention is not particularly limited, and the expansive material can be a commercially available expansive material product or a substance capable of expanding, such as a macromolecule water absorbing resin or expanded rubber powder.

Mixing: At the beginning of production, delivering 50-70% mass fraction of cement, 10-30% mass fraction of silica fume, 10-30% mass fraction of expansive material and 3-10% maltose of a total mass of healing agent powder to a butterfly-type mixing machine respectively, fully stirring for 5-10 minutes to mix the healing agent powder evenly for later use.

At present, auxiliary materials that can be used for powder dry granulation mainly comprise microcrystalline cellulose (MCC), starch, magnesium stearate, etc. However, a research of the present invention found that: the price of MCC is much higher compared to maltose; since healing agent powders for cement, etc. do not have cohesiveness, and using starch as adhesive requires adding a higher content of starch into the healing agent powder to achieve a better bonding effect, but this will reduce the proportion of effective ingredients in the capsule; as an additive, magnesium stearate will make the healing agent contain certain heavy metals, which will be harmful to human health, and as a long-term project, the admixture used in concrete engineering is not allowed to be harmful to people and the environment; maltose is made from wheat and glutinous rice, and has a wide range of sources, low price, and can play a good bonding role through a low amount of addition, so that it is very suitable to be added into the healing agent powder as an adhesive. To sum up, by considering the factors such as the content of the adhesive, toxic or not and economic benefits, maltose is chosen to use as an adhesive.

Pre-pressing: delivering the mixed healing agent powder to a dry granulator, and a pressure value of the dry granulator is adjusted to 0-10 MPa. Pre-pressing the healing agent powder in the dry granulator to obtain granules, sieving the pre-pressed granules through a vibrating screen with a mesh diameter of 0.15 mm. The healing agent powder remaining in the sieve can be re-entered into the dry granulator for pressing through a feedback unit.

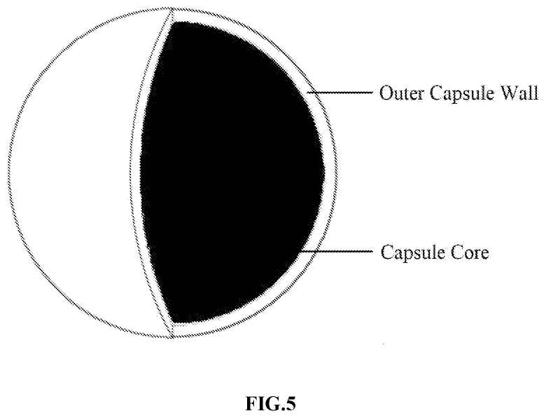

Granulating: pouring the pre-pressed granules into a rotary pelleting machine, starting a compulsory feeding device and adjusting a pressure degree (30-60 kN), a speed (10-40 r/min) and a material filling amount to realize the control of weight, denseness and hardness of capsule core granules for final granulation of capsule core. A pelletizing mold of the rotary pelleting machine as shown in FIG. 4 can be replaced, and the replacement can achieve a preparation of capsule core material with a wide range of granule sizes (1-5 mm) and shapes. Meanwhile, increasing the number of the molds and the rotational speed of the disc can greatly improve the production efficiency of capsule cores.

Film-forming: delivering round spherical granules obtained after the granulation to the pot of a coating machine, pouring 5-10% concentration of PVA aqueous solution into the funnel of a spraying system, adjusting the working frequency of a spray gun and an atomization area of the nozzle of the spray gun to make uniform atomization and large spraying surface. During the clockwise rotation of the pot, spraying the PVA aqueous solution on the granules many times and evenly using the spray gun with high pressure, while blowing hot air of 40-70° C. to remove the moisture from the surface layer of the granules, so that the PVA aqueous solution can be formed to a film quickly. And, adjusting a start frequency and a spraying efficiency of the spray gun, stopping spraying after continuous spraying a certain mass, and carrying out a next round of spraying after the PVA aqueous solution sprayed on the surface of the granules being completely dried and filmed. In this way, the thickness of a capsule wall formed by PVA film can be controlled by the mass of the spraying solution in each round and the number of rounds. Keeping the coating machine working continuously until a uniform and stable PVA film is formed on the surface of each the granule. After the PVA film wrapping is completed, placing the granules in a drying oven for 2-4 hours and removing, and bagging and storing the granules after sieving out clusters of bonded granules using a split sample sieve. In this way, the high-strength self-healing capsule granule is prepared.

According to the replacement of the size of the mold of the rotary pelleting machine, the mass production of capsules within the range of granule size of 1-5 mm can be realized. Wherein, the size of 5 mm is not the upper limit of the granule size, and reasons of that the 5 mm is chosen as the upper limit of the granule size are: 1. the hardness of the capsule will decrease if the granule size thereof is too large, and it will have a greater negative impact on the performance of the basal body if being mixed into the cement-based material basal body; 2. when the granule size of the capsule is large, it may be broken during the stirring in the production of cement-based materials; 3. because of the small density of capsules, the capsules are easy to float during the vibration process, and cannot be evenly distributed in the basal body.

The present invention will now be described in further detail with reference to the following specific examples, which should be noted as illustrative rather than limiting.

In the following examples, the expansive material used is HME®-I hydraulic concrete magnesium oxide expansive material produced by Jiangsu Sobute New Materials Co., Ltd.

### Example 1

The present invention discloses a high-strength self-healing capsule and a supporting production process thereof, improving a cohesive effect of healing agent powder in a capsule core by adding maltose and solving the problem of poor flowability of the healing agent powder by using a dry granulator to pre-press, and achieving controlled granule size and high-efficiency production using a rotary pelleting machine. The steps for preparing the high-strength self-healing capsule are as follows:

Storing: healing agent powders such as cement, silica fume and expansive material, and maltose powder as adhesive being contained in storage devices, respectively.

Mixing: at the beginning of the production, delivering maltose, cement, silica fume and expansive material in the storage devices to a butterfly-type mixing machine through a conveyor such as a conveyor belt, respectively; wherein a mass ratio of the maltose, the cement, the silica fume and the expansive material is 3:57:20:20. Stirring for 5 minutes using a Butterfly-valve stainless steel mixing machine to make the materials disperse and mix evenly.

Pre-pressing: delivering the mixed healing agent powder to a dry granulator, and adjusting the pressure value to 6 MPa for pre-pressing. A vibrating screen with a mesh diameter of 0.15 mm was provided on a granule outlet of the dry granulator to separate the granules from the un-pressed healing agent powder. Taking out the granules, and feeding the un-pressed healing agent powder into an inlet by a feedback unit for reuse.

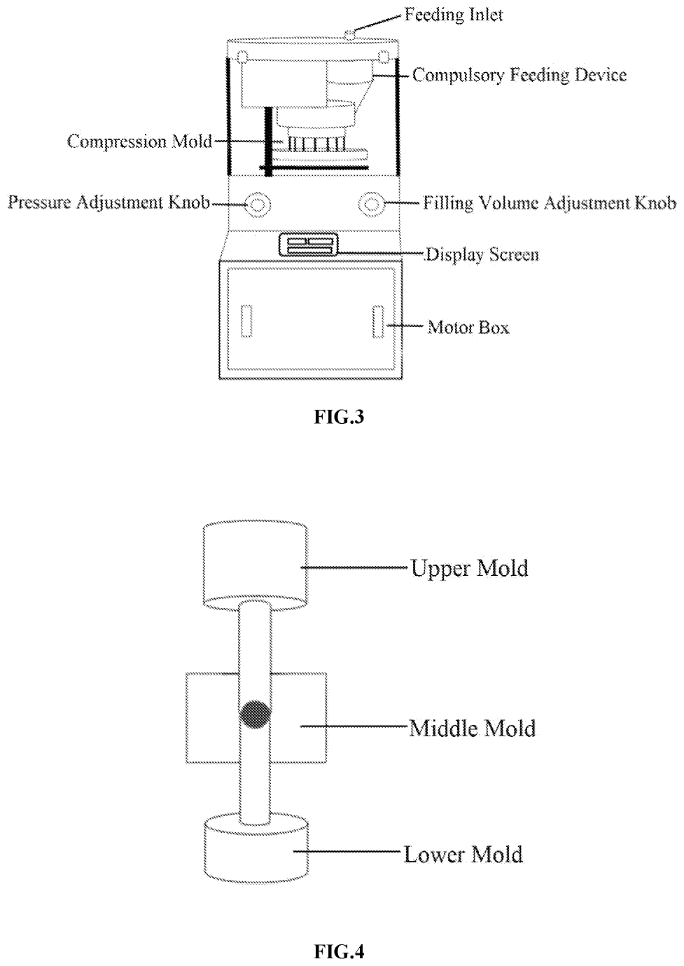

Granulating: starting a rotary pelleting machine and setting a rotary speed to 30 r/min, then observing an operation of a compression mold of the machine, and the operation is qualified if there is no jamming and collision, and then using the machine after it runs smoothly. The machine as shown in FIG. 3, feeding fine granules completing the pre-pressing into a feeding inlet, forcing the fine granules into the compression mold by starting a compulsory feeding device (the rotary speed of the compulsory feeding device is determined by the flowability of the healing agent), observing the state of granules obtained by pressing, and appropriately adjusting the pressure and the filling volume by turning a pressure adjustment knob and a filling volume adjustment knob (if the granules are loose, increase the pressure and the filling volume; on the contrary, decrease the pressure and the filling volume), until a complete spherical capsule core with a certain hardness can be produced. In the pressing process, as shown in FIG. 4, the capsule core granules completing the pressing by an upper mold and a lower mold is ejected from a middle mold by the lower mold. Increasing the number of the molds and the rotary speed of a disc can greatly improve the production efficiency. Checking the quality of granules frequently, such as grain weight, hardness, surface finish, and adjusting the parameters in time if problems are found.

Coating: putting the spherical capsule core granules into a pot of a coating machine, and pouring 5% concentration of PVA aqueous solution into a funnel of the coating machine; adjusting a working frequency of a spray gun (start every 30 s) and an atomization area of the nozzle of the spray gun. During the clockwise rotation of the pot, spraying the PVA aqueous solution on the granules many times and evenly using the spray gun with high pressure, while blowing hot air of 65° C. to remove the moisture from the surface layer of the granules, so that the PVA aqueous solution can be formed to a film quickly. Spraying 3 g of the PVA aqueous solution with the spray gun each time, pausing the machine after continuously spraying a certain quality of the PVA aqueous solution, and then carrying out the next round of spraying after the PVA aqueous solution sprayed on the surface of the granules is completely dry. The coating machine continues to work until a PVA film with a thickness of 0.2±0.05 mm is formed on the surface of the granules, then obtaining capsules. Taking out and placing the capsules into a drying oven at 40° C. for drying for 3 hours, then obtaining the novel microcapsule granules as shown in FIG. 5.

Testing the obtained capsules using a tablet hardness tester, and a test result shows that: the capsules are spherical in shape and have good flow performance. The hardness of the capsule core is 20 N, which is very high and convenient for the subsequent coating of an outer capsule wall and which will not lead to the rupture of the capsule core; moreover, after coating the PVA outer capsule wall, the hardness of the capsule will continue to increase.

### Comparative Example 1

Compared with Example 1, maltose was not added. The experimental results showed that: without the addition of maltose, the healing agent powder could not be formed by the pressing of the granulator, and the capsule core would be broken when lightly touched, and unable to perform the strength test.

### Comparative Example 2

Compared with Example 1, no pre-pressing was performed. The experimental results showed that: without pre-pressing, the healing agent powder could not enter the compression mold of the rotary pelleting machine due to the poor flowability of the healing agent powder, resulting in the inability to achieve granulation.

Finally, it should be noted that the above description is only the preferred example of the present invention, and is not intended to limit the present invention. Although the present invention has been described in detail with reference to the foregoing example, it is still possible for those skilled in the art to modify the technical scheme described in the foregoing example, or to substitute equivalents for parts thereof. Any modification, equivalent replacement and improvement within the spirit and principle of the present invention shall be included in the protection scope of the present invention.

1. A high-strength self-healing capsule, comprising: healing agent and maltose;
and, a method for preparing the high-strength self-healing capsule, comprising:
mixing cement, silica fume and expansive materials evenly to obtain healing agent powder;
mixing the healing agent powder with the maltose to obtain healing agent composite powder;
pre-pressing the healing agent composite powder to form fine granules;
sieving the fine granules made from the pre-pressing, and granulating to obtain capsule core granules; and
spraying polyvinyl alcohol (PVA) solution to the capsule core granules, while blowing hot air to remove moisture on a surface of the capsule core granules, for the PVA solution to form a film on the surface of the capsule core granules, and then obtaining the high-strength self-healing capsule after drying.

2. The high-strength self-healing capsule according to claim 1, wherein an added amount of the maltose is 3-10% of a total mass of the healing agent powder.

3. The high-strength self-healing capsule according to claim 1, wherein the expansive material may be replaced with macromolecule water absorbing resin or expanded rubber powder.

4. The high-strength self-healing capsule according to claim 1, wherein a granule size of the capsule core granule is 1-5 mm.

5. The high-strength self-healing capsule according to claim 1, wherein conditions of the granulating are: a pressure degree is 30-60 kN, and a rotary speed is 10-40 r/min.

6. The high-strength self-healing capsule according to claim 1, wherein a pressure of the pre-pressing is 0-10 MPa.

7. The high-strength self-healing capsule according to claim 1, wherein a mesh diameter of a screen for sieving the fine granules is 0.12-0.18 mm.

8. The high-strength self-healing capsule according to claim 1, wherein a concentration of the PVA solution is 5-10%.

9. The high-strength self-healing capsule according to claim 1, wherein a temperature of the hot air is 40-70° C.

10. The high-strength self-healing capsule according to claim 1, wherein a condition of the drying is drying for 2-3 hours at 40-50° C.

11. An application of the high-strength self-healing capsule of claim 1 in a self-healing of concrete.
